(19) United States
(12) Patent Application Publication
(10) Pub. No.: US 2026/0330591 A1
(43) Pub. Date: Oct. 22, 2026

(54) HyperFoveation Systems and Methods for Adaptive Image, Video, and Sensor Processing

(71) Applicants: Frank Christian Christofferson, Westminster, CO (US); Tim Wahlers, Green Bay, WI (US); Jeff George, Kent, WA (US)

(72) Inventors: Frank Christian Christofferson, Westminster, CO (US); Tim Wahlers, Green Bay, WI (US); Jeff George, Kent, WA (US)

(21) Appl. No.: 19/650,369

(22) Filed: Apr. 17, 2026

Related U.S. Application Data
(60) Provisional application No. 63/790,024, filed on Apr. 17, 2025.

(51) Int. Cl. G06T 3/00

(52) U.S. Cl. CPC G06T 3/00

(57) ABSTRACT

Systems and methods are disclosed for HyperFoveation, an advanced form of foveation that extends pixel-based processing by grouping enhanced pixel representations, referred to as HyperPixels, into dynamically defined zones with differing quality, resolution, or computational treatment. HyperFoveation enables adaptive allocation of processing, storage, bandwidth, or analysis resources based on perceptual importance, application requirements, sensor characteristics, or optimization objectives. HyperFoveation Zones may be defined according to user gaze, predicted regions of interest, content features, motion, illumination changes, sensor input, or automated control, and may change over time, vary in shape, overlap, or be non-contiguous. The disclosed techniques apply to image and video generation, compression, transmission, analysis, reconstruction, and artificial intelligence training or inference. In some embodiments, HyperFoveation Zones progress through a lifecycle including creation, activation, modification, reuse, suspension, or retirement, independent of individual frames or data instances. HyperFoveation is applied across multiple processing resources, including local, edge, or remote systems, to improve scalability, efficiency, latency, power consumption, and fidelity; however, such distributed operation is not required.

### CROSS REFERENCE TO RELATED APPLICATIONS

This application claims the benefit of U.S. Provisional Application 63/790,024 filed on Apr. 17, 2025, the entire contents of which is hereby incorporated by reference as if set forth in full text, including figures.

### BACKGROUND

The Latin language word “fovea” describes “a pit or depression” and is now commonly used to refer to the area of the retina of animal eyes with greatest visual acuity due to a measurable concentration of visual sensors different from those of the surrounding tissue.

Foveation evolved over millions of years to provide exquisitely effective animal survival cues with minimal cognitive and bandwidth load. Example specializations of foveated vision include peripheral motion threat awareness, precision central focus assessment, pupillary contraction and diurnal signaling. Digital foveation is inspired by foveated animal vision.

Researchers and theorists have studied human vision for centuries. Sir Isaac Newton not only analyzed the visual spectrum but also stuck a needle in his own eye to expand his knowledge.

Yet a detailed understanding of photons and their sensing by the retina is very recent, corresponding to advanced microscopy and imaging systems. After photons are concentrated by lenses, they impact the retina and are partially filtered and combined prior to transmission to the brain via the optic nerve. But this is the tip of the Newtonian needle. As sophisticated as the optics and biology of the retina are, human visual processing is still more complex and less understood. After the transom of the optic nerve is crossed, essentially magic happens as we currently understand it. Add ersatz synthesized imagery generated from dreaming or image recall, and we have decades of puzzle-solving ahead of us at least.

Nature provides many variants of vision and foveation, and with creativity, the evolutionary optimizations can be extended and improved beyond the narrow but important origin of vision.

The most common current application of foveation is in head-mounted image generation systems, often referred to as virtual reality (VR), extended reality (XR), and similar technologies, where it is used in conjunction with eye-tracking to reduce the rendering or transmission burden on a remote system. In a typical implementation, higher spatial resolution is assigned to the foveal, eye-tracked portion of the image, while lower-resolution peripheral regions are blended or otherwise approximated. As described here, HyperFoveation Zones enable a much more complex definition of retinal regions. Depending on the latency and accuracy of the system components, this approach can deliver performance improvements comparable to those achieved through one or more generations of semiconductor advancement.

### GLOSSARY OF TERMS

Alpha buffer—a buffer storing transparency or alpha information associated with pixel or image data.

Application Specific Integrated Circuit (ASIC)—a custom hardware device designed to perform specific computational or processing tasks.

Artificial intelligence (AI)—machine-based intelligence used for optimization, control, training, inference, analysis, or decision-making.

Codec—a compression and decompression method or format used for image, video, or data transmission and storage.

Control plane—A logical layer of a system responsible for generating, managing, and applying control-plane information that governs processing behavior, resource allocation, or coordination, independent of payload data execution.

Control-Plane Information—Information used to determine how data is processed, prioritized, or allocated, including HyperFoveation Zone definitions and associated control directives, and excluding payload data itself.

Database-space foveation—application of foveation principles to data organized in database-space rather than solely in screen-space, image-space, or temporal-space.

Dead-reckoning—predictive information used to estimate motion, position, or state between updates.

Depth buffer—a buffer storing depth or distance information associated with image or rendering data.

Distributed heterogeneous foveation—assignment and combination of foveated workloads across heterogeneous processing resources.

Distributed heterogeneous foveation system—a system that allocates foveated processing across heterogeneous local, edge, and remote resources.

Distributed sensor coordination—coordinated foveation and processing across multiple sensors.

Display buffer—a buffer containing pixel data intended for output, display, analysis, transmission, or inference.

Eye tracking—tracking of eye position or gaze, which may optionally be used as one of multiple inputs for determining regions of interest or HyperFoveation Zones.

Field Programmable Gate Array (FPGA)—a reconfigurable hardware accelerator capable of implementing custom logic or processing pipelines.

Fovea—the retinal area of greatest visual acuity, characterized by a high concentration of visual sensors.

Foveal region—the central, highest-priority image or data region corresponding to the fovea.

Foveation—a vision-inspired technique that allocates greater resolution, quality, or processing to an area of interest, without limitation to display geometry or rendering pipelines.

Foveation controller—a control component that determines foveation or HyperFoveation Zones and allocates resources accordingly.

Heuristic logic—rule-based decision or optimization methods.

Holodeck—a science-fiction-inspired fully immersive simulation concept used as a benchmark for fidelity.

HyperFoveation—a coined term extending the HyperPixel concept when combined with foveation to enable advanced, adaptive, and optimized processing systems.

HyperFoveation Intelligence Engine—One or more analytic, heuristic, or intelligence-based processes configured to generate, update, or refine HyperFoveation Zone definitions based on control-level inputs.

HyperFoveation Zone—Control-level descriptive information defining membership, boundaries, priorities, and associated processing characteristics of one or more HyperFoveation Zones, independent of payload data.

HyperFoveation Zone lifecycle—The temporal progression of a zone definition, including one or more of creation, activation, modification, reuse, suspension, or retirement, independent of individual frames or data instances.

HyperFoveation Zone Store—A logical or physical store that maintains HyperFoveation Zone definitions as persistent control-level information, independent of imagery, sensor data, or other payload data processed by the system.

HyperPixel—an enhanced form of a pixel, applicable to displays, image buffers, and image-processing pipelines, potentially dynamic, non-scaler, and multi-dimensional.

HyperShader—a coined term extending shader concepts to encompass distributed, customized, shader-like computation across diverse architectures.

Internet of Things (IoT)—networked distributed sensors or devices.

Intermediate compositor node—a node that performs intermediate rendering, compositing, scaling, or preprocessing functions.

Machine learning—data-driven optimization or learning methods.

Mixed bit-depth representation—a pixel or buffer representation using non-uniform or variable bit allocation.

Multiuser shared foveation—foveation supporting multiple users simultaneously.

Non-regional compression—compression applied to irregular, non-rectangular, or non-contiguous pixel groupings.

Optimization engine—an automated or semi-automated system using AI, heuristics, or manual input to assign HyperFoveation Zones and resources.

Output subsystem—a component that merges distributed or parallel outputs into a combined result for display, analysis, transmission, or inference.

Passthrough video—video captured by a headset or device and passed through for display or processing.

Payload plane—A logical layer of a system in which payload data, including imagery, sensor samples, or analytic inputs, is processed according to control-plane information.

Peripheral region—a lower-priority image or data region surrounding a foveal region.

Post-processing buffer—a buffer holding image or data used for post-processing operations.

Predicted gaze—an estimated future eye-gaze position used for foveation or HyperFoveation.

Processing stage—A logical or physical step in a data pipeline in which data is generated, transformed, analyzed, compressed, transmitted, stored, or rendered.

Region of interest (ROI)—a selected area receiving higher priority or processing emphasis.

Retinal map—a foveation coordinate structure inspired by retinal vision, without requiring anatomical correspondence or eye-tracked alignment.

Screen-space/Depth-space/Database-space/Temporal-space—logical spaces in which HyperFoveation Zones may be defined.

Tensor core—specialized processing hardware optimized for tensor or matrix operations.

Variable Rate Shading (VRS)—a shading methodology that varies shading resolution across regions of an image.

### DISCUSSION OF RELATED PRIOR ART

### Patents

### US 2014/0247277 A1—Foveated Image Rendering (Microsoft)

This published application discloses a display centric foveated rendering technique in which image resolution is spatially varied based on eccentricity from a focal region. The foveated regions are recalculated per frame and applied within the rendering pipeline. The approach is limited to display rendering and does not define persistent, data centric zone abstractions or coordinate multiple processing stages.

U.S. Pat. No. 9,727,991 B2—Foveated Image Rendering (Microsoft)

The issued counterpart to US 2014/0247277 A1. This patent formalizes eccentricity based foveated rendering using eye tracking and layered resolution regions within a display pipeline. The system focuses on rendering optimization and does not address generalized resource orchestration or zone persistence across non rendering stages.

U.S. Pat. No. 10,147,227 B2—Variable Rate Shading (Microsoft)

This patent introduces hardware level techniques for varying shading rates across different regions of a render target. Variable Rate Shading (VRS) operates entirely within the GPU rendering pipeline and controls a single computational resource dimension (shading density). It does not disclose zone intelligence, adaptive control layers, or cross pipeline coordination.

### WO 2019/226093 A 1—Foveated Rendering Using Eye Motion (Meta)

This international application describes tiled foveated rendering driven by real time eye motion tracking. Rendering tiles near the gaze point are processed at higher fidelity than peripheral tiles. The disclosure remains constrained to display space rendering and tile based shading, without persistent zone abstraction or multi resource orchestration.

U.S. Pat. No. 12,141,935 B2—Foveated Rendering Using Eye Motion (Meta)

The issued U.S. patent corresponding to the Meta PCT filings. It represents a mature, modern implementation of gaze contingent foveated rendering for AR/VR systems. The scope is explicitly limited to display pipelines and eye tracked resolution control, and does not generalize foveation beyond rendering or display stages.

U.S. Pat. No. 7,894,682 B2—Multi Point Predictive Foveation (AT&T/Gamehancement) An early predictive foveation reference that estimates future regions of interest to guide bandwidth efficient image transmission. The system emphasizes predictive ROI placement for compression and transmission efficiency, rather than persistent, reusable zone definitions or coordinated multi resource control.

### US 2021/0064904 A1—Eye Tracking to Adjust ROI for Compression (Sony)

This application uses eye tracking information to define regions of interest that influence video encoder parameters. ROI definitions are transient and codec specific, and the disclosure is limited to compression quality control rather than generalized system level orchestration.

WO 2023/057666 A1—Electronically Foveated Dynamic Vision Sensor (CSIC) This reference discloses sensor level foveation in which pixel groups are electronically aggregated or subsampled at the hardware level. The approach operates entirely within image sensors and does not address higher level control abstractions, data centric zone definitions, or downstream processing coordination.
U.S. Pat. No. 11,363,282 B1—System and Method for Low Latency Distributed Image Compression and Composition (Quantum Radius)

This patent describes distributed image compression and composition using hyperpixel based representations and shared virtual compression buffers. While it introduces advanced per pixel representation and distributed coordination concepts, the disclosure focuses on compression and buffering architectures rather than persistent HyperFoveation Zones or a generalized control plane.

### US 2024/0423465 A1—Retinal Foveation System and Method (Quantum Radius)

This application discloses retinally modeled foveation using Hyperpixel Retinal Maps and gaze driven inputs to guide distributed foveated rendering and processing. It represents a biologically grounded, retinal specific embodiment and remains dependent on gaze and retinal correspondence rather than generalized, data centric zone orchestration.

### US 2019/0287495 A1—Depth Based Foveated Rendering for Display Systems (Magic Leap)

This application describes a depth aware, gaze dependent foveated rendering system for AR/VR displays. Rendering resolution is varied based on a user fixation point and object depth. The disclosure is display centric and limited to rendering resolution control.

U.S. Pat. No. 11,238,836 B2—Depth Based Foveated Rendering for Display Systems (Magic Leap)

The issued version of US 2019/0287495 A1. It confirms the scope of Magic Leap's approach as a gaze locked, depth based rendering optimization confined to display pipelines, without persistent zone intelligence or multi resource coordination.

### EP 3608717 B1—Wide FOV Imaging Devices With Active Foveation (Magic Leap)

This European patent discloses optical and sensor level foveation for wide field imaging devices. The techniques adjust sensor or optical characteristics rather than data centric processing behavior, and do not introduce system level orchestration abstractions.

### Scholarly Articles

Scholarly work related to foveation spans perceptual vision science, computer graphics, image and video compression, hardware accelerated rendering, and biologically inspired machine vision. While this literature provides important foundational insights, it generally treats foveation as a perceptual or stage specific optimization, rather than as a persistent, system level control abstraction.

Research on retinal and perceptually motivated foveation models selective processing based on the non uniform acuity of the human visual system, typically using eccentricity models, log polar mappings, or contrast sensitivity functions to vary spatial resolution or quality across an image (e.g., Da Costa & Do, IEEE Transactions on Image Processing, 2014: https://compimg.ece.illinois.edu/publications/Foveation.pdf). These approaches are largely display centric and focus on perceived visual fidelity rather than coordinated system behavior.

Subsequent work on eye tracked, gaze dependent foveated rendering dynamically repositions regions of higher rendering fidelity according to a user's fixation point, particularly in AR/VR and near eye display systems (e.g., Roth et al., Journal of Eye Movement Research, 2017: https://www.ncbi.nlm.nih.gov/pmc/articles/PMC7141096/; Zhang et al., arXiv 2025: https://arxiv.org/pdf/2503.23410.pdf). Such systems remain tightly coupled to display pipelines and typically adjust only rendering resolution or shading density.

Related efforts in hardware level rendering optimization, including variable rate shading and multi resolution shading, reduce GPU workload by spatially varying shading rates within a render target (see NVIDIA VRWorks Variable Rate Shading documentation: https://developer.nvidia.com/vrworks/graphics/variablerateshading). These techniques operate within the graphics pipeline and control a single class of computational resource.

In parallel, region of interest (ROI) image and video compression research allocates higher fidelity to selected regions during encoding to improve bandwidth efficiency or perceptual quality (e.g., Ungureanu et al., Sensors, 2024: https://www.mdpi.com/1424-8220/24/3/791; Samarathunga et al., IEEE 2024: https://strathprints.strath.ac.uk/88129/). ROI definitions in this literature are generally transient and confined to codec specific stages.

Additional studies explore enhanced pixel representations, such as superpixels and hyperpixels, which aggregate multiple samples or features to improve segmentation, sensing, or spectral analysis (e.g., Williams et al., arXiv 2024: https://arxiv.org/pdf/2403.16901.pdf). These representations typically function as data structures rather than as persistent abstractions for coordinating processing across systems.

Finally, biologically inspired foveated vision and AI models apply foveal peripheral sampling strategies or attention mechanisms to reduce learning or inference complexity within specific neural architectures (e.g., Lukanov et al., Frontiers in Computational Neuroscience, 2021: https://www.ncbi.nlm.nih.gov/pmc/articles/PMC8645638/; Blauch et al., arXiv 2026: https://arxiv.org/pdf/2602.03766). Such approaches are algorithm specific and do not provide a generalized mechanism for coordinating heterogeneous resources across multiple processing stages.

Collectively, the scholarly prior art advances foveation as a perceptual, algorithmic, or hardware localized optimization, but does not disclose a persistent, data centric zone abstraction that operates as a system level control mechanism for coordinating diverse computational resources across heterogeneous pipelines independent of display, gaze tracking, or retinal correspondence.

### Limitations of the Related Art

Across the foregoing categories, prior art approaches to foveation and prioritized image processing generally rely on one or more limiting assumptions. Many techniques define foveated behavior using retinal, gaze-dependent, or perceptual models, and are therefore constrained by display geometry, eye-tracking accuracy, or anatomical correspondence. Other approaches are confined to specific processing stages, such as rendering, shading, or encoding, and typically address only a single class of computational resource, such as pixel resolution, shading rate, or bitrate allocation.

In addition, regions of interest or foveated areas in the related art are commonly transient, stage-specific, or codec-specific constructs, rather than persistent abstractions that can be reused or coordinated across multiple processing stages or heterogeneous systems. Enhanced pixel representations, superpixels, and biologically inspired foveated vision models similarly focus on localized processing efficiency or algorithm-specific optimization, without providing a generalized system-level mechanism for coordinating diverse processing resources.

Accordingly, while the related art describes numerous techniques for selectively processing portions of visual data, it does not disclose a generalized, data-centric zone abstraction defined over enhanced pixel representations that can persist independently of individual frames or pipelines and be used to coordinate allocation of multiple heterogeneous computational resources across distributed systems, processing stages, and applications independent of display, gaze tracking, or retinal correspondence.

### BRIEF DESCRIPTION OF FIGURES

FIG. 1 is a typical interpretation of the invention when applied to an expansive lifecycle of HyperFoveation employed throughout a multi-device distributed camera, database, AI, and immersive rendering system.

FIG. 2 is a block diagram illustrating distributed HyperFoveation functions applied to an end-to-end synthetic rendering pipeline.

### SUMMARY

This summary is provided to introduce a selection of concepts in a simplified form that are further described below in the Detailed Description. This summary is not intended to exclusively or exhaustively identify key features or essential features of the claimed subject matter. Nor is it intended as an aid in determining the scope of the claimed subject matter.

In general, basic foveation is well understood as prior art, as are distributed computing and remote rendering. While these techniques can improve system performance, they do not by themselves overcome the substantial increase in fidelity required to meet the field of view (FOV), responsiveness, and resolution expected by the human visual system in the physical world. When rendering is not sufficiently real-time or accurate, the brain attempts to compensate, often resulting in cognitive strain and motion sickness.

The Holodeck device as envisioned by the Star Trek television franchise teases the benefits possible where the highest fidelity imagery and digital simulation are achieved. Given the tapering of Moore's law and Dennard scaling, it is unlikely that the current approach to generational advancement of single GPUs will provide this within the next few decades.

Instead, the invention incorporates HyperFoveation implemented on multiple discrete systems operating in parallel to provide in aggregate a much more powerful system than otherwise might be available on one local or even one more powerful remote foveated system. Such a system is not constrained by location, heterogeneity, or symmetry. For instance, in an expansive case, a cloud server GPU-heavy cluster system from one cloud provider may be combined with one from another cloud provider which may also be combined with a network service provider's edge system which may be combined with a neighbor's network-rented resource which may be combined with one or several devices in the end user's home or office to deliver superior imagery in real time to a single user.

Accordingly, the invention is intended to substantially accelerate the Holodeck fidelity timeline and broaden the advantages of foveation to analogous non-visual applications.

To help describe the invention to those skilled in the art, we employ several terms.

“HyperPixel” is a previously introduced term that extends the concept of a pixel—a contraction of picture element—as used in displays, image buffers, and image processing pipelines. The conventional pixel model is comparatively restrictive, reflecting its historical association with early display and broadcast technologies, including fixed color spaces and constrained memory organizations such as uniform 8 bit buffers.

A HyperPixel represents an advancement beyond this conventional pixel model. HyperPixels may be dynamic rather than static, may be geometric or non geometric, and may incorporate intelligent, adaptive, or state dependent behavior. In contrast to scalar pixel representations, HyperPixels may be based on vector, matrix, or higher order data representations, thereby enabling more flexible, expressive, and efficient processing, storage, and transmission pipelines.

“HyperFoveation” is a term coined herein to extend and enhance the HyperPixel concept when combined with foveation, thereby enabling advanced and optimized systems that improve the capabilities of both. Foveation in image or video processing generally refers to the selective allocation of higher quality, resolution, bandwidth, or computational effort to regions of greater importance, while allocating reduced resources to lower priority regions. This approach is inspired by the human visual system, in which fine detail is perceived primarily in the fovea—the central region of focus—while peripheral regions are perceived at lower spatial fidelity.

HyperFoveation builds upon and generalizes traditional foveation techniques. At its simplest, HyperFoveation may replicate basic two-zone foveation models; however, more generally, HyperFoveation supports grouping HyperPixels into any number of zones. Zone definitions may be static or dynamic and may change from display frame to display frame, scene to scene, or event to event. Zones may correspond to regions of the human eye, including the fovea, parafovea, perifovea, peripheral retina, or regions characterized by differing rod and cone cell densities, and may further be tailored to specific user characteristics, including visual capabilities, deficiencies, or disease states. Unlike conventional foveated rendering techniques that depend on user eye tracking to define a fixed or tiled high resolution display region, HyperFoveation defines arbitrarily structured zones over enhanced pixel representations and is not limited to display pipelines, real time eye tracking, or rendering tasks.

HyperPixels may belong to multiple zones concurrently, and zones need not be geometrically contiguous. Zone definitions may be driven by user gaze or visual focus, predicted gaze, application logic, image or video content, detected objects such as faces, motion characteristics, illumination changes, sensor input, graphics generation pipelines, or automated optimization. Zone definitions may further be used to control processing stages, including sensing, rendering, compression, distribution, and parallel execution. In addition, zone definitions may be dynamically adjusted to support artificial intelligence directed processing, workload distribution, and parallelism across one or more processing resources.

“HyperShader” is a new term we coin here to extend the root “Shader”, described to the public by Pixar in the 1980s. Shaders started as basic illumination computation functions performed on pixels, but advanced to very powerful languages and compilers employed even for non-image computation. They targeted embarrassingly parallel architectures such as the GPU (Graphics Processing Unit) and evolved mostly in lockstep with GPUs to handle increasingly complex and capable combinatorial pixel and geometry operations, adding specialization and optimization such as ray tracing cores and tensor cores as those algorithms and their implementation improved. Advancing the art, a HyperShader would consider even more extensive, less homogenous parallelism, easing constraints on monolithic pipeline architectures. Unlike conventional shaders, HyperShaders are invoked and parameterized according to HyperFoveation Zone definitions shared across multiple processing stages and heterogeneous resources.

More pointedly, the HyperShader demonstrates the benefits of HyperFoveation, where for example millions of physically dispersed, specialized but coordinated shaders compiled for hundreds of different architectures could apply customized functions on billions of pixels in parallel according to the needs and optimized description of distributed foveation, whether for rendering pipelines, artificial intelligence system training, arrays of satellites coordinated for sensing, or new applications.

The present invention arose as we advanced our HyperFoveation implementation and testbed while considering not only distributed foveated rendering, but also broader improvements to hardware processor and image-system architectures, as well as analogous photonic implementations for new products employing cameras or other sensors. Although we had previously invented distributed GPU systems (U.S. Pat. No. 6,115,038A), combined shading of geometry and textures (U.S. Pat. No. 6,222,555B1), variable bit-depth approaches to single images (U.S. Pat. No. 11,363,282B1), distributed coordinated buffers (US20190379944A1), and digital mapping of the retina (US20240423465A1), we recognized the need for a more generalized architecture and method suitable for a wide range of distributed use cases. Such use cases may include cost-or power-optimized systems using chiplets, customized processors, networked heterogeneous processors, neural execution units, or any combination thereof in software and hardware, thereby enabling novel implementations.

### DETAILED DESCRIPTION

The system, method, and apparatus will now be described by use of example embodiments. The example embodiments are presented in this disclosure for illustrative purposes and are not intended to be restrictive or limit the scope of the disclosure or the claims presented herein. In all embodiments, HyperFoveation Zones are defined over enhanced pixel representations (HyperPixels) and persist as a common abstraction across one or more processing stages and resources.

Control-plane information, as used herein, refers to information that governs how data is processed, prioritized, scheduled, routed, or allocated within a system, including definitions, policies, constraints, priorities, optimization objectives, timing information, or lifecycle state, and excluding payload data itself.

Control-plane information may include HyperFoveation Zone definitions, zone lifecycles, processing directives, resource allocation parameters, predictive information, or system-state indicators, and may be generated, stored, communicated, or applied independently of imagery, sensor samples, or other payload data.

The disclosed embodiments include overcoming the fidelity barrier in the XR market by aggregating disparate or specialized resources to enable data and imagery of potentially many orders of magnitude higher quality.

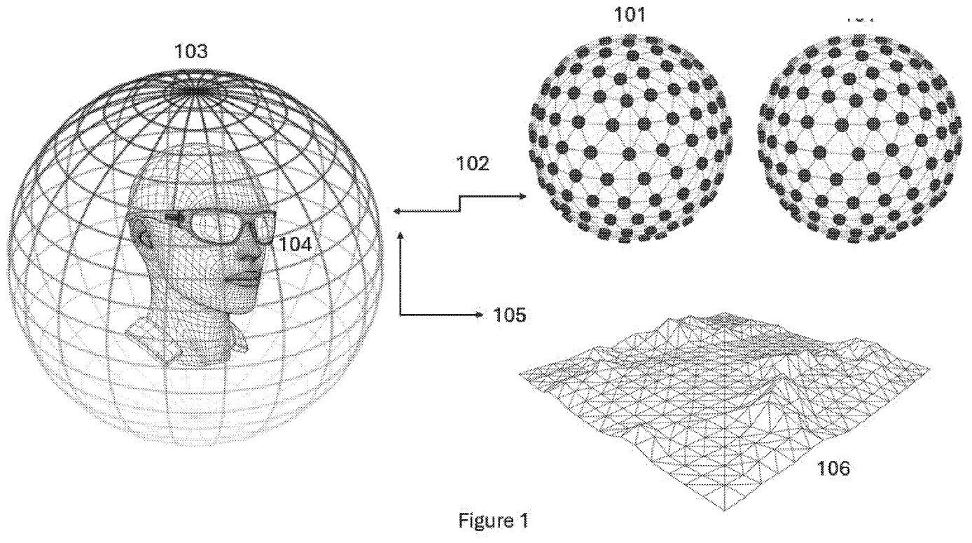

FIG. 1 shows a typical interpretation of the invention when applied to an expansive lifecycle of HyperFoveation employed throughout a multi-component distributed camera, database and immersive rendering system. Example use cases for this interpretation include object identification and iteration by human and/or automated operators such as fire suppression systems, intruder identification systems, or moving object threat analysis and countermeasure control. In this full lifecycle example, a stereo HyperFoveated camera system is communicated and projected to one or more immersed human and/or AI users. The example dual constellation of external camera systems 101 may be mounted on masts or suspended from aircraft or drones or one or more satellites and consists of a number of discrete cooperative HyperFoveation-enabled devices capable in aggregate of providing extremely high arc-second resolution stereo multispectral imagery. The addition of stereo capabilities enables features such as photogrammetry. The number and capabilities of each device are determined by multiple requirements, such as cost, power, sensor data gathering performance, memory, communications bandwidth, spectral bands, resolving power, stereo separation, and focal length. Each camera system consists of at least sensors, lenses, HyperFoveation processors, data compression encoders, and either independent communication systems or bus connectivity to a communications system 102. Each camera system has HyperPixel maps coordinated with every other device and receives dynamic view information from users or automated systems and may employ HyperShaders for sensor image preprocessing, fusion or postprocessing. The result is use-case optimized, optimally compressed HyperFoveated data for each frame. Each distributed system thus each capture a moment of imagery of an area of interest, independently parallelize reduction and optimization of image data applying relevant view and foveation, independently or in concert communicate via a network 102 to be reintegrated appropriately for user projected view 103 for each user 104. The HyperFoveated imagery may be communicated on the same communication medium in parallel or relayed to a stereo photogrammetry analysis and scene understanding heuristic, AI training system and/or AI neural execution system 105 for subsequent lowest latency integration into digital twin databases 106.

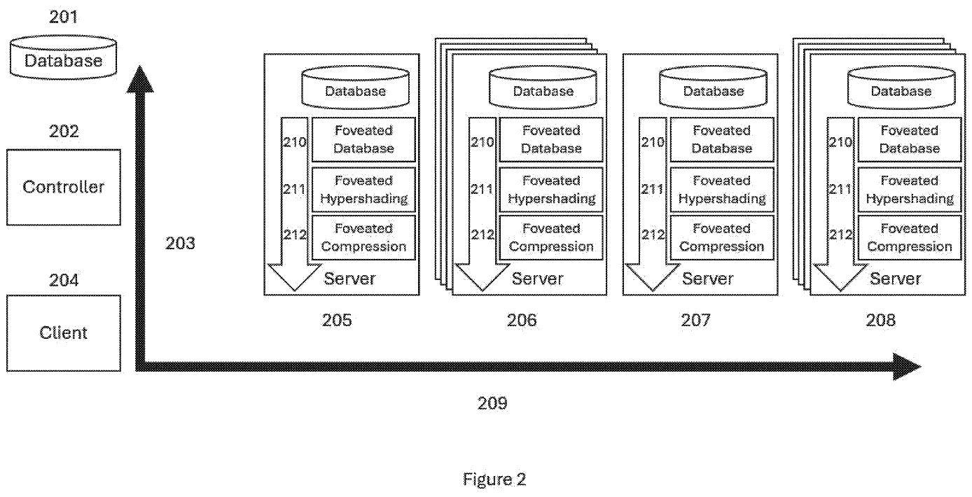

FIG. 2 shows simplified data flow of a HyperFoveated image rendering pipeline creating frames of imagery on a distributed client/server device system, demonstrating the use of HyperFoveation to enhance multiple stages of the pipeline in a coordinated fashion on multiple heterogenous devices. In the example, a digital twin database 201 containing all relevant geometry, texture, simulation and HyperFoveation maps is distributed in a device-optimized HyperFoveation fashion over bidirectional network 202 to each device by the HyperFoveation controller 203. In the example each device has unique service locations, such as local on-board client rendering subsystem 204, local rendering server 205, edge cluster rendering servers 206, cloud service provider A server 207 and cloud service provider B cluster server 208. Each frame, all server devices are sent appropriate current client viewpoint and parameter information and frame timing coordination, 209. Based on this information, each device applies their HyperFoveation parameters to commence their portion of the image rendering pipeline, reducing per-frame rendering and simulation requirements with custom per-frame database optimizations 210. These database interpretations and all rendering pipeline optimizations and features may be modified dynamically according to the influence of the HyperFoveation parameters coordinated with a variety of system performance and coordination parameters, such as dynamism of viewpoint, memory buffering, communications bandwidth, compression requirements and latency. Each device then progresses to rendering unique HyperFoveation-optimized portions of the image (such as their assigned HyperFoveation Zones) 211, invoking optimal HyperShaders as appropriate. Subsequently, each HyperFoveated rendering device samples and packages into a message 212 appropriate zone image data, optionally enhancing that compression with optimally profiled traditional image codecs, including shaping of parameters such as color palette or compression settings. Each rendering device then communicates its optimized message back over the network to the client device for a combination of the messages, decompression, optional HyperFoveation-trained neural upscaling, and display.

The disclosed embodiments further include dynamically adapting a user's system or a service to the needs of an end user via techniques such as described in our prior patent, US20190379944A1, where optimization is automated. This invention enhances that invention by extending the use of HyperFoveation in expansive distributed use cases. Parallel networked foveation with arbitrary system capability provides more options for heuristic, machine-learned, or AI-directed optimization of every element, ranging from dynamic selection or modification of resources, network graphs, databases, retinal maps, application sub-components, or any other element of the foveation system. Any combination of AI, human, or heuristic assignment of these optimizations is possible.

The disclosed embodiments further include foveating and distributing passthrough video from headsets to more than one server resource, improving computation capacity and lowering latency of the overall system. This may be optimized by retaining prior scene knowledge on a distributed basis.

The disclosed embodiments further include distributing, controlling, and coordinating sensors, such as cameras, to combine their acuity while optimizing transmission as needed, using HyperFovea-based algorithms. In both synthetic imagery generation and sensor-source implementations, an analogy to the invention is phased array radar. Similarly, the invention seeks to combine multiple synthesizers or sensors to enable substantially parallel operation, applying and extending image HyperFoveation concepts as the key unifying innovation for coordinating multiple devices for consumption by humans, machines, or AI systems. This includes integration of remote sensors, such as cameras, and the transmission of such foveated data to additional or intermediate automated consumers, such as image recognition systems, artificial intelligence (AI) systems, teams of human operators, or combinations thereof.

The disclosed embodiments further include using system data to increase insights into human vision, machine vision, sensor refinement as well as unique opportunities for dynamic or improved system optimization. The invention considers applying billions of pixels per second produced by such a system, along with knowledge of system, user, and foveation parameters to create training data for AI for various purposes and automate and iterate such training.

The disclosed embodiments further include combining human and automated AI training with integration of real and non-real-time data. An example of improved use would be for automatic driving software optimization.

The disclosed embodiments further include creating distributed foveation applications not considered real-time. The concept of area of interest is distinct from human-responsive eye-tracking at the origins of foveation and is useful for sensor applications.

The disclosed embodiments further include implementing mass relay of foveated first responder or law enforcement cameras. The cameras themselves may be improved with the invention, but foveation may also be employed by operator direction or automation, followed by distribution of the source to a relay node.

The disclosed embodiments further include combining the transmission of a HyperFoveated signal. For instance, different portions of the foveated image in a camera view may be sent via multiple methods or services to improve redundancy or total bandwidth. HyperFoveation Zones may change in real-time and can be driven by the human vision system, application content, sensor capability, computational workload, or resource optimization. Different HyperFoveation Zones may have different requirements for the quality of the signal or communications path.

The disclosed embodiments further include enabling a service where users are provided benefits for participating in foveated advancement, such as players or sensor operators tuning foveation by responding to cues or interaction. The improved distributed system may be employed to extend prior art employment of eye-tracking or behavior analysis by increasing resolution, visual complexity, or flexibility of real-time adaptation.

The disclosed embodiments further include supporting multiple users simultaneously, whether each in a headset or shared viewers of large screen displays with non-invasive eye-tracked input for each user. In these scenarios, either additional optimizations are possible for XR joint databases, rendering and transmission or combinatorial foveation optimizes shared display support.

The disclosed embodiments further include employing fixed foveation in the event eye tracking is unavailable or where fixed foveation provides other benefits, such as area-of-focus influenced by a director in a movie or a sportscast.

The disclosed embodiments further include optionally employing standard video codecs in novel ways in concert with foveation. Many current codecs are non-real-time, as they are designed for buffered, high-latency streaming. However, some features and profiles of codecs may assist compression for remote systems even in real-time systems.

The disclosed embodiments further include partial use of codecs in a combinatorial pipeline or unique profiles or even different codecs for each discrete server and even for each individual HyperFoveation Zone on each server. Groups of pixels can take advantage of parallelization in new ways.

The disclosed embodiments further include employing existing codecs for non-regional compression, where groups of adjacent or non-adjacent or irregularly organized pixels can virtually combine into images suitable for the form factor of codecs designed for traditional rectangular imagery. Additionally, bit-depth variances of pixel descriptions may make use of codecs via approximations, such as combining sub-standard bit combinations. An example would be a peripheral HyperPixel composed of 5 bits of blue, 2 bits of green, and 1 bit of red may use an 8-bit compression profile, compressing and decompressing effectively, but with goal-based tolerance for loss and potential post-decompression alteration. In the invention, these features may be combined with overhead information to provide better use of codecs through methods such as channel scaling or dynamic color correction to allow for maximal effect for the user or application.

The disclosed embodiments further include distributing foveated depth buffers, alpha buffers, or image post-processing buffers, computing, compressing, transmitting and merging various sources. These buffers may use standard or nonstandard compression as an optional feature, as described above.

The disclosed embodiments further include algorithmically generating HyperFoveation Zones for any or all sub-zones, as well as islands within the contours of a foveation map or adjustments to device or rendering pipeline unique situations.

The disclosed embodiments further include sharing dead-reckoning or other predictive information to any and all nodes simultaneously.

The disclosed embodiments further include a method for optional or partial intermediate compositor nodes which may perform parallel or pipelined functions to the overall feature, performance or latency benefit of the dynamic system. Simple examples are separate antialiasing, scaling or antialiasing node, but more complex examples are shared CPU database preprocessing nodes or variable rendering assignments for HyperFoveation Zones imaging as they interact with focus.

The disclosed embodiments further include synchronizing rendering or display buffers. For example, a parallel display buffer may independently ingest and transfer pixels via multiple paths, unlike current conceptually scanned single buffers. Foveated display buffers may have dynamic characteristics and may be employed to minimize power consumption or maximize capabilities such as organic light-emitting diodes (OLED) lighting, color or contrast.

The disclosed embodiments further include a method with no limitations on local, cluster, edge, or remote contributors to the resource pool for foveation. Each may have single or multiple components, on the motherboard, bus or network. Motherboards may have multiple buses in the future to support this, for example. Mixed types of devices may be employed at any or all distributed nodes, even in combination, such as standard compute components, custom computers for AI, Field Programmable Gate Arrays (FPGAs), or Application Specific Integrated Circuits (ASICs). Network variance for each device may be compensated through timing synchronization based on common global high-resolution clocks and flexibility assigning pixel or sensor throughput, frames, image complexity, screen subdivisions, screen depth subdivisions and HyperFoveation Zones on a dynamic basis. Redundancy or overlapping coverage may be employed to limit or remove artifacts.

The disclosed embodiments further include coordinating image or data foveation services by advertising and allocating independent resources, such as a neighbor's computer or an off-hour enterprise resource. Mixed system capability, mixed vendors, dynamic and mixed combinations of resources, such as non-1:1 CPU/GPU assignments, including one-to-many and many-to-one, are envisioned.

The disclosed embodiments further include a method to dither and pattern HyperFoveation maps, including blank data to reduce bandwidth and allow visual integration of gaps.

The disclosed embodiments further include mixing AI-based scaling and frame interpolation for combinatorial client/server optimization. Each client and server may employ these techniques differently.

The disclosed embodiments further include coordinating algorithmic modification to existing shared retinal foveation maps leading to novel uses such as multi-user combinatorics for large displays or multiple simultaneous personal displays, or temporally disjoint streaming of this data for multiple participants or additional layered algorithmic analysis.

The disclosed embodiments further include using variable rate shading (VRS) methodologies as a part of the distributed foveation optimization. Industry VRS may be used in part or in combination with other shading optimizations, such as our more flexible retinal map methodology and be tuned for each distributed component or HyperFoveation Zone.

The disclosed embodiments further include a method to partition XR rendering servers in screen-space and depth-space, database-space, or temporal-space as well as by HyperFoveation Zone. All may be used simultaneously.

The disclosed embodiments further include a method to optimize one or more servers where multiple users share a spatial or coherent foveation presence. This may involve databases or imagery or configuration optimization. An example would be a large corporate avatar meeting where extremely detailed databases enhance the value over personal communications.

The disclosed embodiments further apply HyperFoveation to any type of sensors or any platform, such as multiple video or CCD imagers, ground sensors, radars, sonars, drones, aircraft, and satellites. Foveation for data reduction may be combined with reprojection, AI enhancement, and other combinatorial or distortion correction methods to pre- or post-process data for the intended purpose of human or automated consumption. As an example, ground penetrating radar or thermal imaging from multiple resources such as satellite, drone, and surface may foveate their data to a fusion node controlled by an operator to better pinpoint survivors in a collapsed city. As another example, an orbiting array of 144 satellites could be employed to scan for forest fires in real-time over a wider area than otherwise possible, where each satellite has a shared foveation map, participates in the distributed sensor foveation, reduces their portion of the bandwidth-reduced sensor imagery, and then sends that to the command user as a foveated, dynamic stream. This includes AI improvement before or in parallel to the user or users'viewing. In this example, a command operator may scan and present a different view from the firefighting drone or aircraft operator, who may employ a separate foveated database or display system cueing on the primary operator's view. As described previously, this system may include combinatorial viewing for multiple users or systems, based on the allocated bandwidth and the needs of the various viewers' or viewer automated systems.

The disclosed embodiments further include a method to apply foveation to lower power requirements in dispersed systems or human implants, where power considerations for transmission or algorithmic optimization are essential. If human dream vision cognition is available, it may be applied to transmit this optimally. Similarly, enhanced ocular prosthetics may employ this method. Similarly, widely dispersed Internet of Things (IoT) sensors for audio, video, seismic, motion or other uses are embodiments. Foveation concepts may be applied to systems with variable temporal requirements.

The disclosed embodiments further include a method for real-time remote viewing of immersive broadcasts. Arrays of stereo cameras may be accessed by multiple viewers with foveated composition or separation, and parallel compression systems may be employed to reduce latency. Large camera sensor arrays arranged in a radial fashion may be employed to provide more complete immersion or provide zoom capability. Separated arrays of foveated cameras that are either large or even separated could be algorithmically integrated to also simulate gimbaled camera operation.

The disclosed embodiments further include a method or device to improve remote viewing applications such as doorbells, pet cameras, or remote real-estate drone walkthroughs, allowing products to use improved multiple sensors or gain immersive viewing benefits.

The disclosed embodiments further include a service architecture for foveated distributed game consoles, where applications may “dial” performance up and down as needed, invoking performance not provided by single or obsolete systems by themselves. For example, single current or old Xbox Cloud servers may be combined via foveation to enable performant use for a single immersive game application or partitioned in any combination to support multiple users.

The disclosed embodiments further include processor and computation optimization. Although processor technology has improved to the point of implementing hundreds of billions of transistors on a single die, it is also true the price, power and thermal cost of these advancements are severely constraining. Yet a car or drone can't have a data-center sized computer onboard, nor respond glacially. Such an optimized implementation would allocate resources with foveation as a primary parameter, including use of variable bit registers and memory allocation. Four-bit math takes less power than 64-bit math, and is appropriate in various foveated circumstances, as an example.

The disclosed embodiments further include applying foveation to improve training and neural execution for image upscaling and frame generation. Used in concert with human reaction-based testing to dynamic imagery, the efficiency and accuracy of these systems may be optimized. The invention envisions improving the pipeline of super scaling and similar techniques by employing foveation to guide the training and neural execution of the image rendering pipeline. Such training would literally focus on the most important foveal area of training data, also accounting for the different values ascribed to peripheral, motion or other cues.

The disclosed embodiments further include extending foveation imagery to multiple dimensions. For example, photogrammetry derives depth information from multiple images can be improved and extended by employing many disparate spatial and even temporal sensors combined with the invention to perform volumetric, trained scaling. Although 3D rendering techniques like Gaussian Splatting create more optimized rendering paths, increased data complexity requires more focused scene description and reconstruction to attain real-time, highest resolution, interactive capability. This invention provides a path for that solution.

1. A HyperFoveation system comprising:
a. a HyperFoveation Zone Store configured to maintain one or more HyperFoveation Zone definitions defining groupings of HyperPixels;
b. a HyperFoveation Intelligence Engine configured to generate, update, or refine the HyperFoveation Zone definitions based on control-level inputs;
c. a HyperFoveation Controller configured to apply the HyperFoveation Zone definitions to coordinate allocation of processing treatment or computational resources for data associated with the HyperFoveation Zones across one or more processing stages; and
d. one or more output modules configured to provide information derived from the HyperFoveation Zone definitions to one or more processing systems or display systems.

2. The system of claim 1, wherein the HyperFoveation Zone definitions persist independently of individual frames, images, or payload data instances.

3. The system of claim 1, wherein the HyperFoveation Zone definitions are maintained as control-plane information separate from payload data processed by the system.

4. The system of claim 1, wherein the HyperFoveation Intelligence Engine comprises one or more analytic, heuristic, rule-based, or machine-learning processes.

5. The system of claim 1, wherein the HyperFoveation Intelligence Engine operates asynchronously with respect to payload data processing.

6. The system of claim 1, wherein one or more HyperFoveation Zones are noncontiguous, overlapping, irregularly shaped, or dynamically reconfigured.

7. The system of claim 1, wherein HyperFoveation Zone definitions are defined in one or more of screen-space, depth-space, database-space, temporal-space, or combinations thereof.

8. The system of claim 1, wherein the HyperFoveation Controller coordinates application of the HyperFoveation Zone definitions across multiple processing stages selected from sensing, rendering, compression, transmission, storage, or artificial intelligence processing.

9. The system of claim 1, wherein processing associated with different HyperFoveation Zones is performed by heterogeneous processing resources including two or more of CPUs, GPUs, tensor cores, FPGAs, ASICs, or AI resources.

10. The system of claim 1, wherein each HyperFoveation Zone progresses through a lifecycle comprising one or more of creation, activation, modification, reuse, suspension, or retirement.

11. The system of claim 1, wherein processing associated with different HyperFoveation Zones is distributed across two or more of local, edge, remote, or cloud-based systems.

12. A method of HyperFoveation, comprising:
a. maintaining one or more HyperFoveation Zone definitions defining groupings of HyperPixels as control-plane information;
b. generating or updating the HyperFoveation Zone definitions using one or more analytic, heuristic, or intelligence-based processes based on control-level inputs;
c. applying the HyperFoveation Zone definitions to coordinate allocation of processing treatment or computational resources for data associated with the HyperFoveation Zones across one or more processing stages; and
d. providing output information derived from the HyperFoveation Zone definitions to one or more processing systems or display systems.

13. The method of claim 12, wherein the HyperFoveation Zone definitions persist independently of individual frames, images, or payload data instances.

14. The method of claim 12, wherein generating or updating the HyperFoveation Zone definitions is performed asynchronously with respect to payload data processing.

15. The method of claim 12, wherein control-level inputs include one or more of user gaze, predicted gaze, application logic, content features, motion characteristics, illumination changes, sensor input, system state, or automated optimization objectives.

16. The method of claim 12, wherein applying the HyperFoveation Zone definitions coordinates processing across multiple stages selected from sensing, rendering, compression, transmission, storage, or artificial intelligence processing.

17. The method of claim 12, wherein each HyperFoveation Zone progresses through a lifecycle comprising one or more of creation, activation, modification, reuse, suspension, or retirement.

18. The method of claim 12, wherein processing associated with different HyperFoveation Zones is performed by heterogeneous processing resources including two or more of CPUs, GPUs, tensor cores, FPGAs, ASICs, or AI resources.

19. The method of claim 12, wherein processing associated with different HyperFoveation Zones is distributed across two or more of local, edge, remote, or cloud-based systems.

20. The method of claim 12, wherein the output information comprises control directives, processing parameters, or routing instructions derived from the HyperFoveation Zone definitions.
